(19) United States
(12) Patent Application Publication
(10) Pub. No.: US 2015/0317155 A1
(43) Pub. Date: Nov. 5, 2015

(54) Editing Multiple Attributes of Multiple Assets in an Editor

(71) Applicant: MPH, Inc., San Francisco, CA (US)

(72) Inventors: Jeffrey Norman Grills, Austin, TX (US); Matthew Adam Shaw, Austin, TX (US)

(21) Appl. No.: 14/701,355

(22) Filed: Apr. 30, 2015

Related U.S. Application Data
(60) Provisional application No. 61/987,233, filed on May 1, 2014.
(60) Provisional application No. 61/987,237, filed on May 1, 2014.
(60) Provisional application No. 61/987,243, filed on May 1, 2014.
(60) Provisional application No. 61/987,282, filed on May 1, 2014.

(51) Int. Cl. G06F 9/44

(52) U.S. Cl. CPC G06F 8/71

(57) ABSTRACT

A system and a method are disclosed for taking data input from, and writing data back to, multiple sources that are composed of multiple types of storage types and configurations. This data is revision controlled and presented to the user in a unified table format for ease of correlation. The received data also can be modified or otherwise changed and written back to the disparate sources from which the data was obtained.

### CROSS REFERENCE TO RELATED APPLICATIONS

This application claims the benefit of U.S. Provisional Application Nos. 61/987,233, 61/987,237, 61/987,243, and 61/987,282 each of which was filed May 1, 2014, and each of which are incorporated by reference in their entirety.

### BACKGROUND

1. Field of Art

This disclosure relates to computer gaming engines. More specifically a non-centralized, no-SQL, document driven database game development and deployment tool is described that provides numerous advantages over current development and deployment tools.

2. Description of the Related Art

Typically game designers have to do a search and one by one change a property on an asset. Some solutions have allowed for multi-select of assets, and being able to set an individual property for all assets that are selected. The interface to do so is generally a list, and when viewed in a property grid, what is seen is data that is common to all assets selected. The interface is used to override properties by editing one of the properties all the data shares. Although the change can happen quickly, the layout of data is typically not as useful. Moreover, it is very error prone to be able to change something on a large number of objects at once without a more finite context of what is being are changed.

Another way this has been done is to export all asset properties, either for a scene or matching a search query to an Excel document or CSV file, allow editing via an external editor, and then importing all the changed data. This gives designers the full usage of another tool like MICROSOFT EXCEL to work with large amounts of data, but can be error prone in cases that a scene changes and assets no longer exist or have significantly changed. There can also be a lot of error since designers typically will not see the results of their editing until the import has happened and all the data has changed. Further, they will not get an undo stack for individual changes and this may cause a lot of problems if they significantly changed data.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

Figure (FIG.) 1 shows how data and changes are logged by an individual user and propagated to the master services database.

FIG. 2 illustrates an example embodiment of a developer configurable N-dimension data gathering and editing system.

FIG. 3 illustrates one embodiment of components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

The present system allows designers to review and edit data that is pulled from multiple sources that are composed of multiple types of storage systems. This system can support nearly any type of graph, directed acyclic graph file system, CSV file, or database. Essentially any source of easily separated data. This is displayed to user as a cohesive data set, any changes are then stored to the appropriate source, all changes are tracked with, for example, a transaction log.

### Example Collaborative Game Development Environment

Figure (FIG.) 1 illustrates an embodiment of a collaborative game development environment 100 for developing digital games for platforms such as, for example, gaming consoles, PCs, tablets, and mobile devices. The collaborative game development environment 100 enables multiple game developers, potentially working in different remote locations, to collaboratively develop a game. Furthermore, the collaborative game development environment enables managers to effectively manage, track, and generate reports detailing progress of the game under development.

The collaborative game development environment 100 comprises a first local network 110-a connecting a first plurality of developer clients 112-a at a first location and a second local network 110-b connecting a second plurality of developer clients 112-b at a second location. Each of the developer clients 112 is coupled with a local database 114. The local database 114 may be stored, for example, in a storage device directly attached to a developer client 112 or elsewhere on the local network 110. In some embodiments, one or more of the local databases 114 may be shared among two or more developer clients 112 on the same local network 110. The first local network 110-a and the second local network 110-b are each coupled to a wide area network 120 (such as the Internet) to connect the first local network 110-a and the second local network 110-b to a master cloud services server 130. The master cloud services server 130 provides access to and controls a master content database 140, an asset file storage 150, and a master telemetry database 160 that are each accessible to each of the developer clients 112. In an embodiment, all network traffic for collaboration, asset sharing, and development telemetry pass through the master cloud services server 130. The master cloud services server 130 may provide services such as, for example, authentication, database storage, file storage and collaboration tools. It is noted that the master content database 140 also may be referenced as the master services database.

The asset file storage 150 stores binary data for digital assets used in the game under development. As used herein, an “asset” comprises a digital file or object representing game data. Examples of assets include scripts, meshes, animations, textures, shaders, audio files, etc. The asset file storage 150 additionally stores revisions to assets as they are being updated during development of the game.

The master content database 140 stores metadata associated with the game including notes about implementation, usage, materials, measurements, etc. The information dictates where, how, and when objects appear in the game, and contains all world, level, execution, and packaging data. The master content database 140 furthermore stores a history of all revisions made to the game under development and project data including changes to executable code, metadata, and other components for the game under development. In one embodiment, the master content database 140 stores associations between digital assets and various metadata. The master content database 140 may indicate, for example, how certain assets are being applied in the game under development (e.g., what textures are applied to a given object, what level and location the object appears, characteristics associated with the asset, etc.). In one embodiment, the master database 130 use a no-SQL database that uses a concept of documents rather than rows and tables.

The master telemetry database 160 stores all telemetry data from development. The telemetry data may include, for example, a number of assets submitted by an individual developer, time spent developing assets, changes made to the asset (placement, scale, physics, etc.), notes added by a developer, assets imported, etc. The tracked telemetry thus indicates what actions were performed by different developers during development of the game, how long the actions took, when the actions were taken, and who took the actions. Such tracking enables a manager to access information describing all changes made to the game by various developers throughout all stages of development. The master telemetry database 160 also stores gameplay data such as player data, information about how, where, and when the game is played, level completion information, device information, how the players played, what gameplay decisions were made, etc.

The collaborative game development environment 100 beneficially facilitates real-time collaborative game development and enables game developers to track every change made to the game during development, such as, for example, importing assets, changing positions of assets, writing scripts, etc.). In order to ensure that changes made to an asset by one developer client 112 are propagated to other developer clients 112, the master cloud service. checks whether the asset being changed exists and modifies the corresponding local database 110 to log the change. A log is produced by the master cloud service details the differences made (delta) from the last state of the project. Each local project database 110 is selectively synced with the master content database 140 and so that changes made at one developer client 112 are propagated to the other clients 112.

### Example Data Gathering and Editing

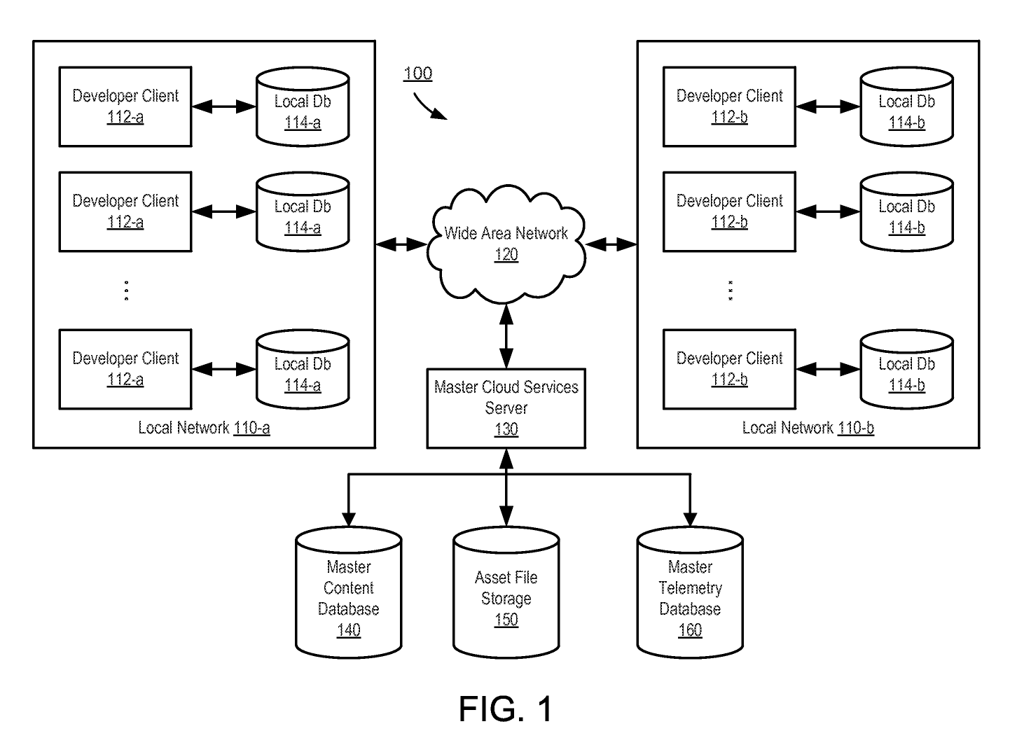

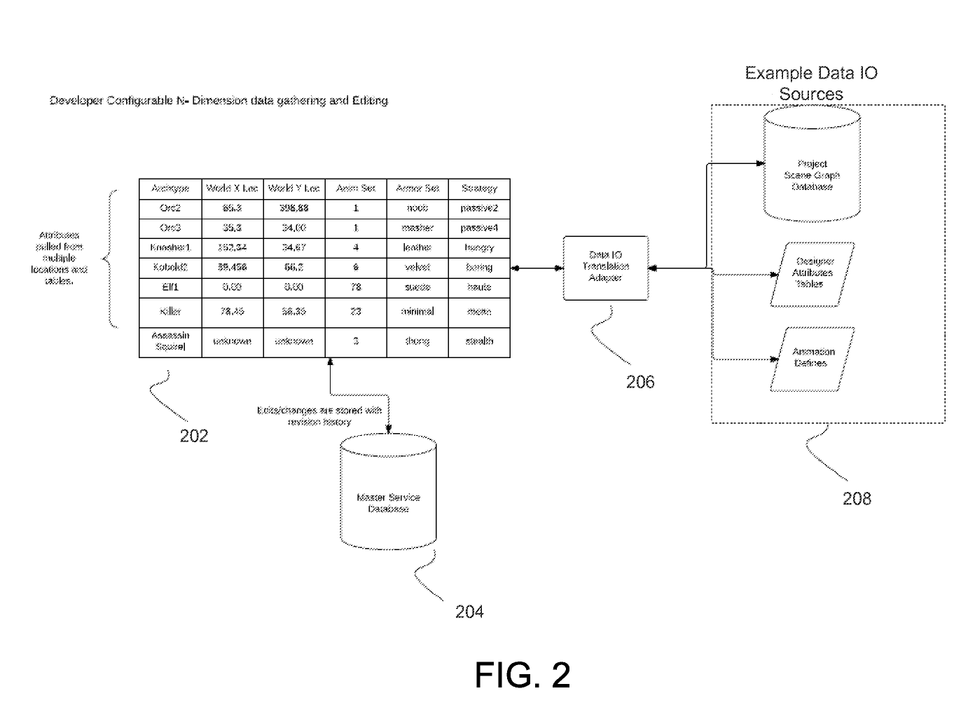

FIG. 2 illustrates an example embodiment of a developer configurable N-dimension data gathering and editing system. The system includes an example attribute table 202, a master service database 204, a data input/output (I/O or IO) translation adapter 206 and one or more data input/output (I/O or IO) sources 208. The attribute table 202 is stored within the master service database 204. The attribute table 202 is accessible by the example data IO sources 208 through the data IO translation adapter 206. It is noted that in this example, the master services database 2014 is similar to the master content database 140 described with FIG. 1.

Looking closer at the system in FIG. 2, the attribute table 202 comprises a user configurable view of many attributes about an asset. These attributes are gathered from N number of discrete sources collected from example data IO sources 208. In this example system configuration, the example attribute table 202 corresponds to an example view that a designer may see when reviewing or editing the attributes of an asset. Examples of assets within the attribute table 202 includes individual character types by row and columns that represent the type of data for the characters such as World X Loc, World Y Loc, etc.

The master service database 204, where the attribute table 202 is stored, also stores other discrete sources of data, for example, project scene graphs and animations definitions. Edits and changes to data in the attribute table 202 are stored with revisions information in the master service database 204. This allows viewing of changes over time and reversion as necessary. It should be noted that the master service database presents a unified view into the graphs, tables and defines that allow the designer to work more efficiently. As these graphs, tables and defines are updated or extended by other sources, the designer maintains access. The data translation adapter 206 is configured to interface between the attribute table 202 and the example data IO sources 208. The data translation adapter 206 understands how to read and write data to the discrete forms of table data.

By way of example operation of the system of FIG. 2, reference is made to an asset such a character referenced as Orc2. Within the example attribute table 202, the value Orc2 corresponds to a character and has data parameters associated with it as shown by the cells in the row associated with Orc2. The asset data for Orc2 may come one or more of the example data sources 208. The Orc2 character starts, in this example, a scene graph representation is stored in the main project scene graph database. The project scene graph database utilizes animation data from a separate table that the designers have setup in a spreadsheet CSV file and an animation control define table from yet another spreadsheet that is updated regularly based on play testing of the game. It is noted that the tables/files are local to a machine of the designer or accessed in a cloud storage, e.g., via a uniform resource locator (URL). These data fields are now part of our assets and usable by the runtime. Accordingly, parameters are added to the attribute table 202 that is sourced from these disparate sources 208. Thereafter the system can track any changes or revisions made to this data in an editor. In particular, the underlying source data may change, but the designer edits are preserved. The user is now able to view this data in a table view as part of the assets entire parameter set as the data is no longer in separate sources, which would not allow easy viewing or correlation.

Rather than merely import all of data into the database, it is noted that in many cases this data is generated by third party tools or real world dynamic data sources. This could be data that is generated daily via telemetry or user play patterns for example. This system allows us to abstract the original source of data.

By way of example, in one embodiment, a system is configured to edit a plurality of attributes for an asset. The system receives a plurality of asset data corresponding to an assert from a plurality of data input/output (IO) sources. The asset may correspond to a character, e.g., Orc2, and the asset data may correspond to characteristics of that asset. At least two received asset data correspond to the asset have different data formats. The received asset data from the different data formats is translated into a universal data format. The system enters the translated asset data into a table. The table is structured so each row corresponds with descriptions of the asset and each column corresponds with a particular characteristic of the asset in the row. The system provides for receiving edits to the translated data in the table to create edited asset data. The system stores changes to the edited asset data into a database, which may be a part of the storage described below.

The edited data may be of use with respect to the IO source from which the data was received. Accordingly, the system is configured to re-translate the edited asset data back to a format corresponding to an IO source of the plurality of IO sources of the translated data. The system transmits (or writes) the re-translated edited asset data to the IO source of the translated data. Hence, the edited data is available for later use in generating a computer designed character.

### Computing Machine Architecture

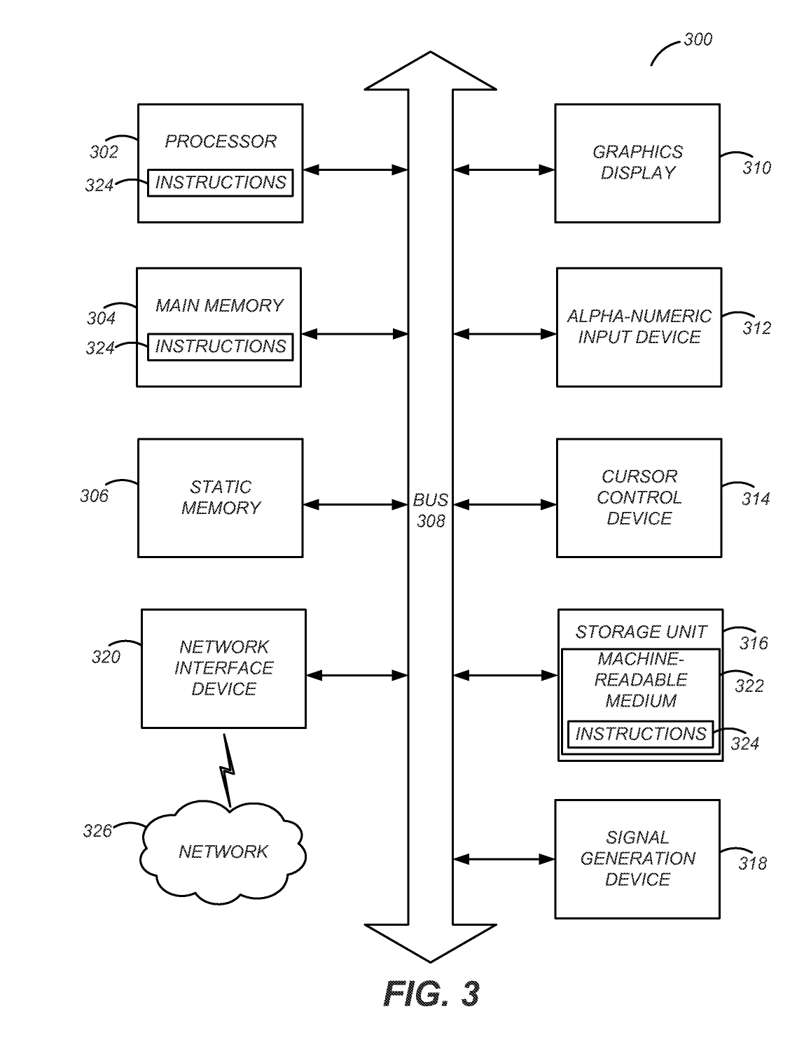

FIG. (FIG. 3 is a block diagram illustrating components of an example machine able to read instructions from a machine-readable medium and execute them in a processor (or controller). Specifically, FIG. 3 shows a diagrammatic representation of a machine in the example form of a computer system 300 within which instructions 324 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions X24 to perform any one or more of the methodologies discussed herein.

The example computer system 100 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include graphics display unit 310 (e.g., a plasma display panel (PDP), a liquid crystal display (LCD), a projector, or a cathode ray tube (CRT)). The computer system 300 may also include alphanumeric input device 312 (e.g., a keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor's cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

The disclosed configuration beneficially imports data assets corresponding to characteristics of a computer generated character from a plurality of disparate IO sources, allows revisions and edits to those characteristics and, where updated, push back (e.g., transmit/write back) those changes to the specific IO source databases from where the characteristics came. Hence, unlike conventional configurations, which primarily received data for generating character configurations, the disclosed configurations push back any changed data that was inputted back to the source from where the data was input. Accordingly, a developer of gaming technology can manipulate characteristics data from multiple sources and then push back any changes to those manipulated characteristics back to the source so that it can be later retrieved and used in other contexts. Hence, when a characteristic is applied in a different way for a character and that characteristic is modified, by writing it back out to the source, that new characteristic is available for use in later contexts when it is retrieved back in.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1 and 2. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 302, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for editing multiple attributes of multiple assets in an editor through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for editing a plurality of attributes of a plurality of assets in an editor, the method comprising:
receiving a plurality of asset data corresponding to an asset from a plurality of data input/output (IO) sources, at least two received asset data of the plurality of asset data corresponding to the asset having different data formats;
translating the received asset data having different data formats into a universal data format;
entering the translated data into a table, the table having each row corresponding to descriptions of the asset and each columns corresponding to a particular characteristic of the asset in the row;
receiving edits to the translated data in the table to create edited asset data;
storing changes to the edited asset data into a database;
re-translating the edited asset data back to a format corresponding to an IO source of the plurality of JO sources of the translated data; and
transmitting the re-translated edited asset data to the IO source of the translated data.

2. The method of claim 1, further comprising transmitting the data from the table for generating a computer designed character.

3. The method of claim 2, wherein transmitting the re-translated edited asset data further comprising writing the re-translated edited asset data to a database of the IO source of the translated data.

4. The method of claim 3, further comprising:
receiving asset data corresponding to edited asset data from an IO source of the plurality of IO sources;
translating the received edited asset data into the universal data format;
entering the translated edited asset data into the table;
editing, a second time, the translated edited asset data in the table to create twice edited asset data;
storing changes to the twice edited asset data into the database;
re-translating the twice edited asset data back to a format corresponding to the IO source of the plurality of IO sources of the translated received edited asset data; and
transmitting the re-translated twice edited asset data to the IO source of the translated received edited asset data.

5. A non-transitory computer readable storage medium comprising instructions for editing a plurality of attributes of a plurality of assets in an editor, the instructions when executed by a processor causes the processor to:
receive a plurality of asset data corresponding to an asset from a plurality of data input/output (IO) sources, at least two received asset data of the plurality of asset data corresponding to the asset having different data formats;
translate the received asset data having different data formats into a universal data format;
enter the translated data into a table, the table having each row corresponding to descriptions of the asset and each columns corresponding to a particular characteristic of the asset in the row;
receive edits to the translated data in the table to create edited asset data;
store changes to the edited asset data into a database;
re-translate the edited asset data back to a format corresponding to an IO source of the plurality of IO sources of the translated data; and
transmit the re-translated edited asset data to the IO source of the translated data.

6. The computer readable storage medium of claim 5, further comprising instructions that when executed by the processor causes the processor to transmit the data from the table for generating a computer designed character.

7. The computer readable storage medium of claim 6, wherein the instructions to transmit the re-translated edited asset data further comprises instructions that when executed by the processor causes the processor to write the re-translated edited asset data to a database of the IO source of the translated data.

8. The computer readable storage medium of claim 7, further comprising instructions that when executed by the processor causes the processor to:
receive asset data corresponding to edited asset data from an IO source of the plurality of IO sources;
translate the received edited asset data into the universal data format;
enter the translated edited asset data into the table;
edit, a second time, the translated edited asset data in the table to create twice edited asset data;
store changes to the twice edited asset data into the database;
re-translate the twice edited asset data back to a format corresponding to the IO source of the plurality of IO sources of the translated received edited asset data; and
transmit the re-translated twice edited asset data to the IO source of the translated received edited asset data.
